(19) United States
(12) Patent Application Publication
(10) Pub. No.: US 2022/0330682 A1
(43) Pub. Date: Oct. 20, 2022

(54) CONTAINER

(71) Applicant: LG HOUSEHOLD & HEALTH CARE LTD., Seoul (KR)

(72) Inventors: Bok Hyun PACK, Seoul (KR); Hae Young HWANG, Seoul (KR); Kyung Hwan MIN, Seoul (KR)

(73) Assignee: LG HOUSEHOLD & HEALTH CARE LTD., Seoul (KR)

(21) Appl. No.: 17/640,118

(22) PCT Filed: Jul. 28, 2020
(86) PCT No.: PCT/KR2020/009930

§ 371 Date: Mar. 3, 2022

(30) Foreign Application Priority Data
Sep. 4, 2019 (KR) 10-2019-0109373

(51) Int. Cl. A45D 40/18; A45D 40/22; A45D 44/00; A45D 33/32; G06T 7/00; H04N 5/225

(52) U.S. Cl. CPC A45D 40/18; A45D 40/221; A45D 44/00; A45D 33/32; G06T 7/0012; H04N 5/2257; A45D 2040/226; A45D 2044/007; G06T 2207/30201; G06T 2207/30088

(57) ABSTRACT

The present invention relates to a container, which provides various functions, comprising: a body having an article accommodation portion; a cover for opening and closing the article accommodation portion; and a camera mounting part disposed on the body or the cover, wherein a recessed portion for exposing a camera disposed on the camera mounting part can be formed on the cover.

### TECHNICAL FIELD

The present invention relates to a container, and more particularly, to a container in which articles such as cosmetic materials and medicines are stored.

### BACKGROUND ART

In recent years, various applications that recommend or guide cosmetics, makeup methods, and the like to a user have been developed. The user may be provided with various information related to cosmetics, makeup methods, and the like through such an application.

For example, the user may refer to a recommended makeup method displayed on a mobile terminal by running a makeup method recommendation application on the mobile terminal. In this case, the user has an inconvenience of having to look a screen of the mobile terminal and a mirror alternately.

In order to solve this problem, it may be required that a method in which a container in which a cosmetic material and the like are accommodated is equipped with a camera, a display, and the like to provide various functions.

### DISCLOSURE

### Technical Problem

The present invention is directed to providing a container capable of providing various functions regardless of an open/closed state.

The present invention is directed to reduce manufacturing costs of a container including a camera, a display, and the like.

The present invention is directed to providing a container in which a user may easily confirm the degree of application of a sunscreen.

### Technical Solution

A container according to an embodiment of the present invention includes a body having an article accommodation portion formed therein, a cover for opening and closing the article accommodation portion, and a camera mounting part disposed on any one of the body and the cover, wherein a recessed portion for exposing a camera disposed on the camera mounting part may be formed on the cover.

The camera mounting part may be disposed on the body.

The camera mounting part may be rotatably supported on the body.

At least one protrusion may be formed in the camera mounting part.

The container may further include a display disposed on at least one of an inner surface and an outer surface of the cover.

The display may display an image captured by the camera mounted on the camera mounting part.

The display may display a region where a sunscreen is detected based on the image captured by the camera.

When the display is disposed on each of the inner and outer surfaces of the cover, one of the display disposed on the inner surface and the display disposed on the outer surface may be turned off depending on whether the article accommodation portion is open or closed.

The cover may be inclined at a first angle that is a maximum angle in a direction of covering the article accommodation portion, a second angle that is a maximum angle in a direction of opening the article accommodation portion, or a third angle that is an angle between the first angle and the second angle.

When the cover is inclined at the first angle, the display disposed on the inner surface may be turned off, and when the cover is inclined at the second angle, the display disposed on the outer surface may be turned off.

When the cover is inclined at the first angle, the display disposed on the outer surface may be turned on and then turned off when a set time elapses, and when the cover is inclined at the second angle, the display disposed on the inner surface may be turned on.

The container may further include a sensing unit for determining whether the article accommodation portion is open or closed.

At least one of a cosmetic material and a puff may be accommodated in the article accommodation portion.

At least one light-emitting unit may be disposed on the cover.

The container may further include a control unit that measures a skin condition of a user's face based on the image captured by the camera mounted on the camera mounting part.

### Advantageous Effects

According to an embodiment of the present invention, since a camera may be used both when a cover is open or closed, there is an advantage that the usability is increased and manufacturing costs may be reduced by reducing the number of cameras.

In addition, since a camera mounting part on which the camera is mounted may be rotated, there is an advantage that the convenience of using the camera is increased.

In addition, since displays disposed on inner and outer surfaces of the cover are appropriately turned on and turned off according to a state of the cover, there is an advantage that it is possible to provide the convenience of confirming information through the display and reduce the power consumption of the display.

In addition, there is an advantage that the convenience of makeup may be provided by detecting and displaying a region where a sunscreen exists and a region where the sunscreen does not exist on a user's face.

### DESCRIPTION OF DRAWINGS

FIG. 1 is a conceptual diagram showing a container system according to an embodiment of the present invention.

FIG. 2 is a control block diagram of a mobile terminal according to an embodiment of the present invention.

FIG. 3 is a control block diagram of a container according to an embodiment of the present invention.

FIGS. 4 and 5 are perspective views of a container according to a first embodiment of the present invention.

FIG. 6 is a perspective view of a container according to a second embodiment of the present invention.

FIG. 7 is a perspective view of a container according to a third embodiment of the present invention.

FIG. 8 is a perspective view of a container according to a fourth embodiment of the present invention.

FIGS. 9 and 10 are perspective views showing a camera mounting structure of a container according to an embodiment of the present invention.

FIG. 11 is a view showing a structure in which a protrusion is formed in a camera mounting part shown in FIG. 10.

FIGS. 12 to 13 are views showing an example of a structure of a sunscreen detection unit according to an embodiment of the present invention.

FIGS. 14 to 15 are cross-sectional views showing a filter switching device and a camera according to an embodiment of the present invention.

FIGS. 16 to 18 are exemplary views of a method in which a container according to an embodiment of the present invention displays an image showing distribution information of a sunscreen.

### MODES OF THE INVENTION

Hereinafter, the present invention will be described in more detail with reference to the drawings.

The suffixes “module” and “part” for elements used in the following descriptions are given just in consideration of easiness in writing the specification, and do not give a particularly important meaning or role by themselves. Therefore, the “module” and “part” may be used interchangeably with each other.

Although the terms first, second, and the like may be used herein to describe various elements, these elements are not limited by these terms. The terms are only used to distinguish one element from another.

A singular representation includes a plural representation unless it represents a definitely different meaning from the context.

It should be understood that the terms such as “include” or “has” used herein, specify the presence of stated features, integers, steps, operations, elements, components, or groups thereof disclosed in the specification, but do not preclude the presence or addition of one or more other features, integers, steps, operations, elements, components, and/or groups thereof.

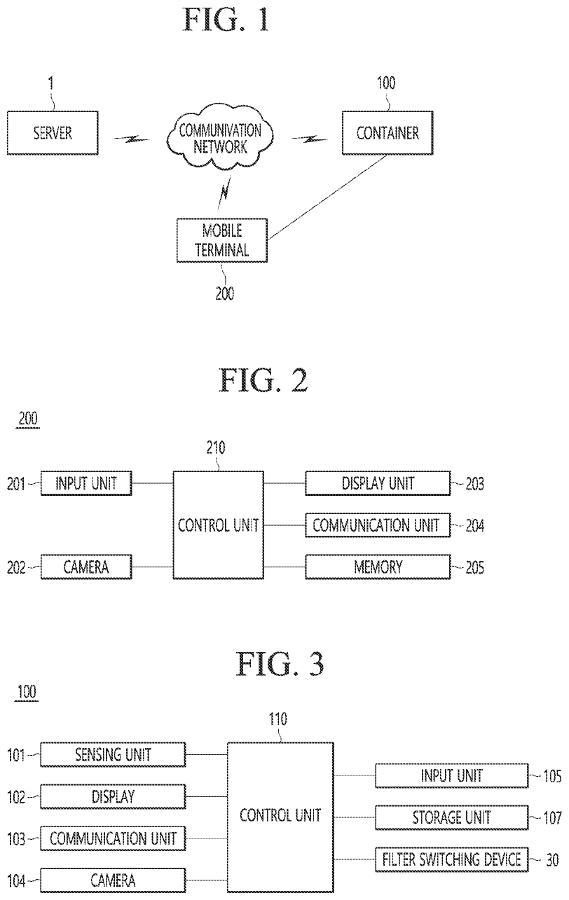

FIG. 1 is a conceptual diagram showing a container system according to an embodiment of the present invention.

The container system may include a server 1, a container 100, and a mobile terminal 200.

The server 1 may transmit/receive data to/from at least one of the container 100 and the mobile terminal 200.

The server 1 may store data related to a function executed in the container 100 and an application executed in the mobile terminal 200.

The server 1 may store current weather information (e.g., ultraviolet (UV) index), product information of a sunscreen on the market, and the like.

The container 100 may accommodate articles such as cosmetics, medicines, and the like. The container 100 may transmit/receive data to/from the server 1 and the mobile terminal 200.

The container 100 may receive the current weather information, the product information of the sunscreen, and the like from the server 1.

In addition, the container 100 may receive information on a cosmetic material stored in the container 100 from the mobile terminal 200.

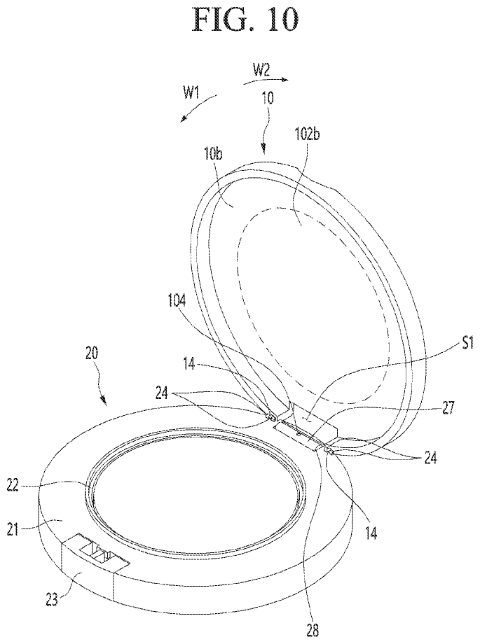

For example, the mobile terminal 200 may recognize a bar code, a QR code, etc. that are attached to a body 20 (see FIG. 10) of the container 100, and through this, information on the cosmetic material stored in the body 20 may be obtained.

The mobile terminal 200 may further include a barcode reader.

The mobile terminal 200 may store the information on the cosmetic material stored in the body 20 in a memory 205 and transmit the information to the container 100.

The information on the cosmetic material may include information such as production date, expiration date, manufacturer, ingredients, and the like. For example, when the sunscreen is accommodated in the body 20 of the container 100, the information on the cosmetic material may include a sun protection factor (SPF) index and a PA index of the sunscreen.

As described above, the mobile terminal 200 may operate in conjunction with the container 100. When a specific application is executed, the mobile terminal 200 may transmit/receive data to/from the server 1 and the container 100, and through this, a specific function may be executed in the container 100.

The container 100 may receive an operation command to a sunscreen detection mode or an operation command to a skin care mode from the mobile terminal 200. A user may input an operation mode of the container 100 through the mobile terminal 200.

Alternatively, the container 100 may further include a separate button (not shown) for receiving the operation command to the sunscreen detection mode or the operation command to the skin care mode from the user.

FIG. 2 is a control block diagram of a mobile terminal according to an embodiment of the present invention.

The mobile terminal 200 may include at least some or all of an input unit 201, a camera 202, a display unit 203, a communication unit 204, a memory 205, and a control unit 210.

The mobile terminal 200 may be a smart phone, but it is merely an example, and may include a wearable device such as a smart watch, a tablet PC, a laptop, a desktop, and the like.

The input unit 201 may receive an input command from the user.

The input unit 201 may be formed of a touch screen or the like or include a physical key button.

The camera 202 may capture the user. For example, the camera 202 may capture a facial image of the user.

The display unit 203 may display various types of information. For example, the display unit 203 may display various information related to the cosmetics included in the container 100.

The communication unit 204 may transmit/receive signals of at least one of the server 1 and the container 100.

The communication unit 204 may transmit information obtained through the input unit 201, the camera 202, or the like, information stored in the memory 205, and the like to the outside. In addition, the communication unit 204 may receive various information from the outside. For example, the communication unit 204 may receive information such as a remaining amount of the cosmetics accommodated in the container 100.

The memory 205 may store data related to the application executed in conjunction with the container 100. In addition, the memory 205 may store data related to the cosmetic material accommodated in the container 100.

FIG. 3 is a control block diagram of a container according to an embodiment of the present invention.

A container 100 may include at least some or all of a sensing unit 101, a display 102, a communication unit 103, a camera 104, an input unit 105, a storage unit 107, a filter switching device 30, and a control unit 110.

The sensing unit 101 may sense information related to the container 100.

The sensing unit 101 may include at least some or all of a remaining amount detection unit (not shown), an opening/closing detection unit (not shown), a position detection unit (not shown), a puff contamination level detection unit (not shown), and an ultraviolet sensing unit (not shown).

The remaining amount detection unit (not shown) may sense a remaining amount of the article accommodated in the container 100. Hereinafter, it is assumed that an article accommodated in the container 100 is a cosmetic material, but it is merely an example for convenience of description. That is, according to the embodiment, the article accommodated in the container 100 may be medicines or the like.

As an example, the remaining amount detection unit (not shown) may be a capacity detection module.

As another example, the remaining amount detection unit (not shown) may be a mass detection module. For example, the mass detection module may be installed on a bottom surface of the article accommodation portion 22, and the mass detection module may detect a change in mass of the article accommodated in the article accommodation portion 22.

The control unit 110 may calculate the remaining amount of the article remained in the article accommodation portion 22 through the mass detection module and control the display 102 so as to output an alarm according to a calculation result.

For example, when a pill is accommodated in the article accommodation portion 22, the control unit 110 may obtain a date when the article accommodation portion 22 is open through an opening/closing detection unit (not shown) described later, and may obtain whether or not to take the pill through the change in mass through the remaining amount detection unit (not shown). Through this, the control unit 110 may obtain a schedule for taking the pill and display the schedule on the display 102.

The opening/closing detection unit (not shown) may detect whether the container 100 is open or closed.

As an example, the opening/closing detection unit (not shown) may be a pressure sensing module. The pressure sensing module may be installed between the cover and the body of the container 100. Specifically, the pressure sensing module may be installed on a surface of the body that is not in contact with the cover when the body is in an open state and is in contact with the cover only when the body is in a closed state. In this case, the control unit 110 may obtain information on an open/closed state of the container 100 based on a change in pressure sensed by the pressure sensing module.

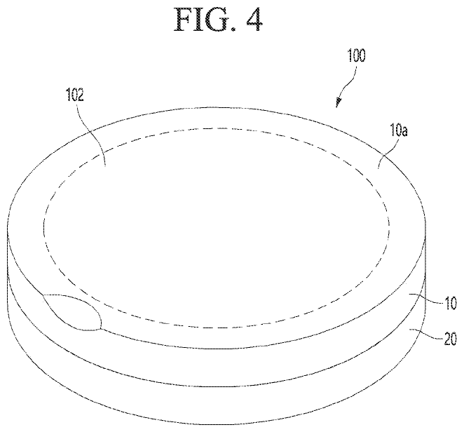

As another example, the opening/closing detection unit (not shown) may be an angle sensing module. As shown in FIGS. 4 to 5 and 9 to 10 described later, when the container 100 is opened and closed in a form in which the cover is inclined, the angle sensing module may be installed on a hinge shaft connecting the cover and the body. In this case, the control unit 110 may obtain information on the open/closed state of the container 100 based on a change in an angle sensed by the angle sensing module.

The position detection unit (not shown) may detect a current position of the container 100. The position detection unit (not shown) may include a global positioning system (GPS).

The puff contamination level detection unit (not shown) may detect a contamination level of a puff stored in the container 100. The puff contamination level detection unit (not shown) may be a fabric sensor. The fabric sensor may sense the contamination level by detecting a change in acidity (pH) or temperature.

The fabric sensor may be disposed in the article accommodation portion 22 described later. Alternatively, the fabric sensor may be disposed on the puff.

The fabric sensor may be formed in a form in which a polymer material is covered with gauze or the like and may include an electronic device that detects a change in resistance. The polymer material included in the fabric material may be wetted by liquid delivered from the puff (not shown), and in this case, the acidity or temperature changes, so that a volume of the polymer material changes. The electronic device in the fabric sensor may measure the contamination level of the puff by detecting the change in resistance due to a change in the volume of the polymer material.

The ultraviolet sensing unit (not shown) may measure an amount of ultraviolet rays.

In addition, the sensing unit 101 may include a laser sensor or the like.

The display 102 may display information related to the container 100.

Alternatively, the display 102 may display current weather such as UV index, today's schedule, and the like. The communication unit 103 may receive current weather information from the server 1 and schedule information from the mobile terminal 200.

In addition, the display 102 may display a usage time of the cosmetic material accommodated in the article accommodation portion 22 by using detection information of the opening/closing detection unit (not shown). In addition, the display 102 may display a remaining amount of the cosmetic material accommodated in the article accommodation portion 22 by using detection information of the mass detection unit (not shown). In addition, the display 102 may display ingredients of the cosmetic material, a place of origin, a makeup method according to external environment information, and the like obtained through the mobile terminal 200.

According to the embodiment, the display 102 may display a logo of a cosmetic material product to be accommodated in the article accommodation portion 22. A watermark for determining whether the cosmetic material is genuine may be provided on the cosmetic material product to be accommodated in the article accommodation portion 22. The control unit 110 may obtain barcode information and watermark information for each production date to determine whether the cosmetic material product is forged.

The display 102 may be a transparent display. For example, the transparent display may be installed on the cover 10 (see FIGS. 4 to 8) or the body 20 (see FIGS. 4 to 8) of the container 100.

When the transparent display is installed on the cover 10, the transparent display may display information on an outer surface or an inner surface of the cover 10.

When the transparent display is installed on the body 20, information may be displayed in a region of the transparent display with which the user's hand is not in contact.

The display 102 may be a flexible display that may be bent according to a shape of the container.

The communication unit 103 may transmit/receive signals to/from at least some or all of the mobile terminal 200 and the server 1.

The communication unit 103 may transmit/receive data to/from other devices through Wi-Fi, Bluetooth, and mobile communication technology (e.g., 3G, 4G, 5G, etc.).

The camera 104 may capture an image. For example, the camera 104 may capture a facial image of a user.

According to the embodiment, the camera 104 may be disposed on a camera mounting part 27 described later.

According to another embodiment, the camera 104 may be disposed on at least one of an outer surface 10a and an inner surface 10b of the cover 10.

According to still another embodiment, the camera 104 may be disposed on a side connecting the outer surface 10a and the inner surface 10b of the cover 10.

The input unit 105 may receive an input command from the user. The input unit 105 may be formed of a touch screen or the like or may include a physical key button (not shown).

For example, the input unit 105 may receive a command for detecting the degree of application of the sunscreen.

The storage unit 107 may store various information related to the container 100. For example, the storage unit 107 may store information on the cosmetics accommodated in the container 100. The cosmetics accommodated in the container 100 may be refilled, and the information of the cosmetics may be changed at the time of refilling. The storage unit 107 may periodically update information on cosmetics currently accommodated in the container 100 and store the updated information. The information on the cosmetics accommodated in the container 100 may include an expiration date of the cosmetics, a date of use of the cosmetics, a remaining amount of the cosmetics, ingredients of the cosmetics, and the like.

The filter switching device 30 may selectively filter light condensed on a lens of the camera 104. Specifically, the filter switching device 30 may pass all incident light in the first mode and may pass only light having a specific wavelength among incident light in the second mode.

The control unit 110 may control the filter switching device 30 in the first mode or the second mode according to the operation mode of the container 100. For example, when the container 100 operates in the sunscreen detection mode, the control unit 110 may control the filter switching device 30 in the second mode, and when the container 100 operates in a normal mode excluding the sunscreen detection mode, the control unit 110 may control the filter switching device 30 in the first mode.

When the control unit 110 operates in the sunscreen detection mode, after controlling the filter switching device 30 in the second mode, the control unit 110 may detect the sunscreen on the user's face.

Specifically, according to a first embodiment, the control unit 110 transmits only ultraviolet light reflected from the user's face to the camera 104 using the filter switching device 30, thereby obtaining an image visualizing the sunscreen. The obtained image may be displayed to the user through the display 102 to selectively display a general video image or the image visualizing the sunscreen according to the mode.

Ultraviolet rays that affect the skin are mainly UVA (wavelength 320-400 nm) and UVB (wavelength 280-320 nm), and UVA is an ultraviolet ray that penetrates deep into the skin, causes skin aging such as wrinkles, loss of elasticity, and pigmentation, and burns the skin dark. UVB is an ultraviolet ray that penetrates to the epidermis or upper part of the dermis and causes erythema, when exposed for a long time, UVB may cause sun burns and, in severe cases, may induce skin cancer. Accordingly, an inorganic sunscreen may block UV rays by physically scattering the incident UVA, and an organic sunscreen may block the UV rays incident on the skin by absorbing the incident UVB and emitting them as other forms of heat and light.

Therefore, a difference may occur in a characteristic of reflecting ultraviolet rays in a region where the sunscreen is applied and a region where the sunscreen is not applied among skin regions of the user.

That is, since some of the incident ultraviolet rays (UVA or UVB) are reflected from a skin surface in the region where the sunscreen is not applied, the camera 104 may capture the reflected ultraviolet ray, since the incident UVA is scattered in a skin region where the inorganic sunscreen is applied, the UVA reflected to the camera 104 is almost eliminated, and since the incident UVB is emitted as other forms of heat or light in a region where the organic sunscreen is applied, the UVB reflected to the camera 104 is almost eliminated.

In general, since UV-blocking cosmetics include inorganic and organic sunscreens, some of the UV rays incident on the skin surface to which the sunscreen is not applied are reflected, and thus when the reflected ultraviolet ray is captured by the camera 104, a luminance signal (a signal in which only UV components are filtered in the filter 31) is considerably lower than that of general visible rays, so that it is displayed as an image captured in black to some extent, whereas most of the ultraviolet rays incident on the region where the sunscreen is applied is scattered or emitted as other forms of heat or light, and thus when the reflected ultraviolet ray is captured by the camera 104, the luminance signal (the signal in which only a ultraviolet signal is filtered by the filter 31) has a black level close to zero, so that it may be displayed as an image captured in very black color.

Therefore, the control unit 110 senses a region where ultraviolet rays are reflected and a region where ultraviolet rays are not reflected in the user's skin by using the camera 104 and the filter switching device 30, so that it is possible to obtain at least one of the application region and the sunscreen application amount.

To this end, the filter switching device 30 may be controlled to pass only light corresponding to an ultraviolet wavelength among the incident light.

Therefore, according to a second embodiment of the present invention, the control unit 110 may obtain sunscreen application information by sensing heat or light emitted from the user's face through the camera 104.

Ultraviolet rays that reach the part of the user's face to which the sunscreen is applied may be emitted as heat and light, and the ultraviolet rays that reach the part of the user's face to which the sunscreen is not applied may be absorbed by the users face. Therefore, the control unit 110 may obtain the region where the sunscreen is applied on the user's face by sensing heat or light emitted from the user's face.

To this end, the filter switching device 30 may be controlled so as to pass only light corresponding to an infrared wavelength among the incident light. That is, the control unit 110 may control the filter switching device 30 to obtain an infrared video image. The control unit 110 may determine a high-temperature region in the infrared video image as a region where the ultraviolet rays are reflected, that is, a region where the sunscreen is applied. In this way, the control unit 110 may detect a region where the sunscreen remains in the user's face by obtaining a region where heat and light are emitted from the infrared video image. Meanwhile, when the control unit 110 uses a thermal imaging camera that captures infrared rays, a microbolometer responding to the infrared rays may be used instead of a charge-coupled device (CCD) or CMOS used as a visible and ultraviolet imaging device.

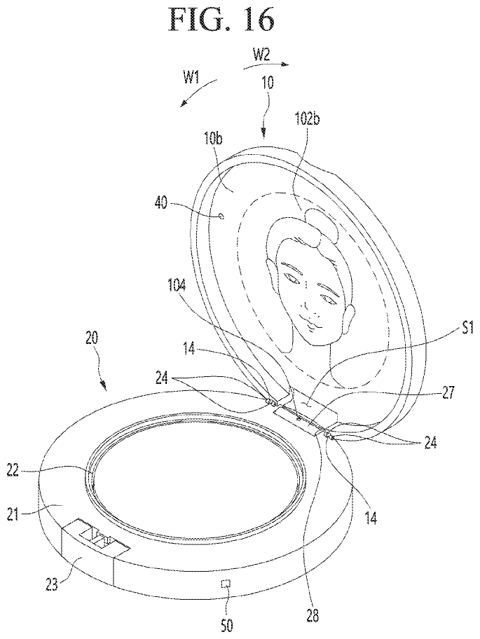

Meanwhile, in the first and second embodiments described above, the container 100 may further include a light-emitting unit 40 for emitting light including ultraviolet rays in order to detect the sunscreen applied to the user's face, and it will be described in detail in FIG. 16. According to the embodiment, the light-emitting unit 40 may be omitted.

According to a third embodiment of the present invention, the container 100 may include a charge-coupled device (CCD) sensor (not shown). The control unit 110 may detect only a region where the sunscreen exists by applying a sunscreen detection algorithm to an image obtained through the CCD sensor.

The control unit 110 may control at least some or all of the sensing unit 101, the display 102, the communication unit 103, the camera 104, the input unit 105, the storage unit 107, and the filter switching device 30.

Next, FIGS. 4 to 8 are perspective views showing a container according to various embodiments of the present invention.

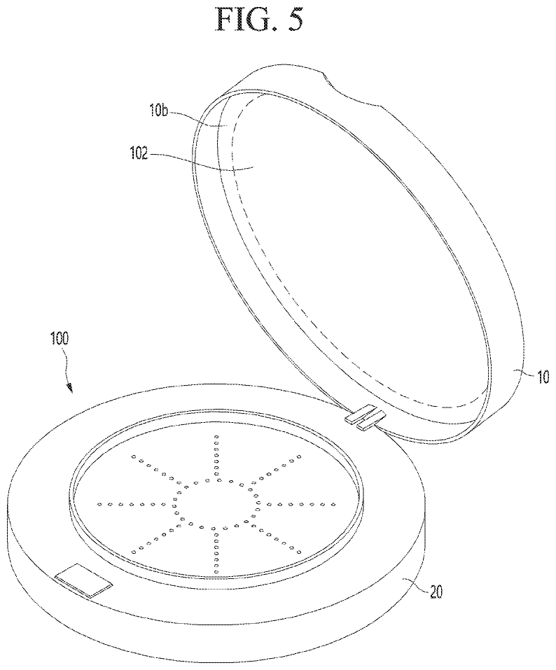

FIGS. 4 and 5 are perspective views of a container according to the first embodiment of the present invention.

A container 100 according to the first embodiment includes a cover 10 and a body 20, and the cover 10 may be hinge-connected to the body 20 to be adjusted to a closed state as shown in FIG. 4 or an open state as shown in FIG. 5.

Cosmetics may be accommodated in the body 20, and when the cosmetics are not used, the cover 10 may cover the cosmetics accommodated in the body 20 to protect the cosmetics.

A display 102 may be formed on the cover 10.

According to an embodiment, the display 102 is formed on each of an outer surface 10a and an inner surface 10b of the cover 10, and the display 102 formed on the outer surface 10a of the cover 10 may be turned on in the closed state, and the display 102 formed on the inner surface 10b of the cover 10 may be turned on in the open state.

According to another embodiment, the display 102 formed on the cover 10 is a transparent display, and the display 102 may display information so that the outer surface 10a of the cover 10 faces the front in the closed state and may display the information so that the inner surface 10b of the cover 10 faces the front in the open state.

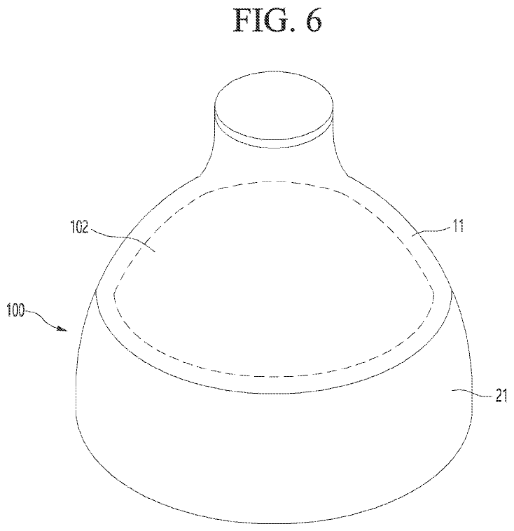

FIG. 6 is a perspective view of a container according to the second embodiment of the present invention.

A container 100 according to the second embodiment may include a cover 11 and a body 21 and have a structure separated from the body 21 as the cover 11 is rotated in one direction, and a display 102 may be formed on a side surface of the cover 11.

The display 102 may be a flexible display. Also, the display 102 may be a transparent display.

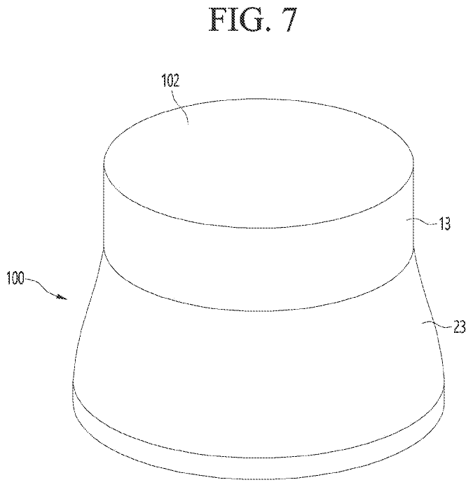

FIG. 7 is a perspective view of a container according to the third embodiment of the present invention.

A container 100 according to the third embodiment may include a cover 13 and a body 23 and have a structure separated from the body 23 as the cover 13 is rotated in one direction, and a display 102 may be formed on an upper surface of the cover 13.

Likewise, the display 102 may be a flexible display. Also, the display 102 may be a transparent display.

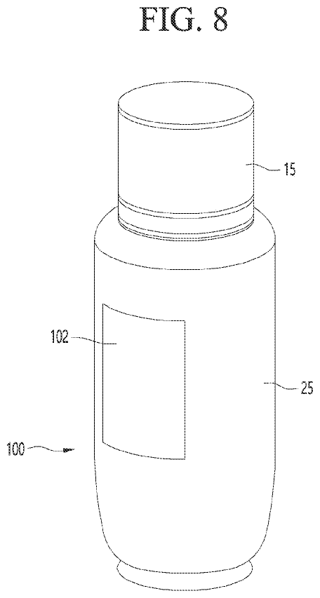

FIG. 8 is a perspective view of a container according to the fourth embodiment of the present invention.

A container 100 according to the fourth embodiment may include a cover 15 and a body 25 and have a structure separated from the body 25 as the cover 15 is rotated in one direction, and a display 102 may be formed on a side surface of the body 25.

Meanwhile, according to an embodiment, as shown in FIG. 8, the display 102 may be a part of the body 25.

According to another embodiment, the display 102 may be formed on the entire side surface of the body 25. In this case, the control unit 110 may determine an information display region by detecting a gaze direction of the user and display information on the information display region of the display 102.

The control unit 110 may detect the gaze direction of the user through a laser sensor (not shown). Alternatively, the control unit 110 may detect the gaze direction of the user by obtaining a portion where the user holds the container 100 through a pressure sensor disposed on the inner surface of the display 102.

According to still another embodiment, two displays 102 may be disposed on the body 25. Specifically, one display 102 may be disposed on a front surface, and another display 102 may be disposed on a rear surface which is the opposite surface. In this case, a bezel of the display 102 disposed on the front surface and a bezel of the display 102 disposed on the rear surface may be disposed on a side surface portion. In particular, the bezel of the display 102 disposed on the front surface and the bezel of the display 102 disposed on the rear surface may overlap in the side surface portion. Since a driver circuit for driving the display 102 is disposed in the side surface portion, the side surface portion may be formed in a flat shape without bending.

In this case, while any one of the display 102 disposed in the front surface and the display 102 disposed in the rear surface is displaying information, the other may be controlled in a transparent display state, and accordingly, the inside of the container 100 may be penetrated. That is, the user may confirm the article accommodated in the container 100 and information displayed on the display 102 together.

As described above, a shape of the container 100 according to the embodiment of the present invention may be various, and the arrangement of the display 100 may be various according to the shape of the container 100.

Meanwhile, the container 100 may further include a camera. Hereinafter, a camera mounting structure will be described in detail assuming that the container 100 has a shape as shown in FIGS. 4 and 5.

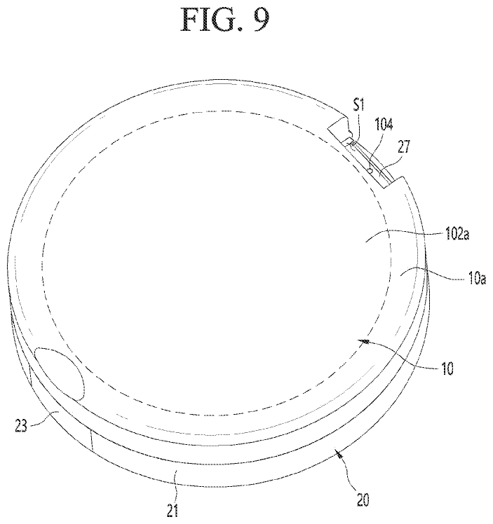

FIGS. 9 and 10 are perspective views showing a camera mounting structure of a container according to an embodiment of the present invention.

A container 100 may include a cover 10 and a body 20 that is hinge-connected to the cover 10.

An article accommodation portion 22 may be formed in the body 20. Cosmetic materials such as a foundation and a sunscreen, puffs, and the like may be accommodated in the article accommodation portion 22.

An article accommodated in the article accommodation portion 22 may be replaced.

The article accommodated in the article accommodation portion 22 may be a dedicated article that may be mounted only in the container 100.

The article itself accommodated in the article accommodation portion 22 may be provided with a barcode or the like.

According to the embodiment, medicines such as pills may be accommodated in the article accommodation portion 22.

The body 20 may have a case 21 in which the article accommodation portion 22 is formed, and a button 23 for controlling the opening and closing of the cover 10 may be provided on the case 23.

The cover 10 may open and close the body 20, in particular, the article accommodation portion 22. A circuit (not shown) in which elements for driving the container 100 are integrated may be disposed inside the cover 10. The control unit 110 or the like may be installed in the circuit (not shown) disposed inside the cover 10.

When the camera 104 is installed in the body 20, the camera 104 may be connected to the control unit 110 by wire or wirelessly.

A hinge shaft 14 may be provided on any one of the cover 10 and the body 20, and a hinge shaft supporter 24 on which the hinge shaft 14 is rotatably supported may be provided on the other of the cover 10 and the body 20. Referring to an example of FIG. 10, the hinge shaft 14 may be provided on the cover 10 and the hinge shaft supporter 24 may be provided on the body 20, but it is merely an example, and thus the embodiment is not limited thereto.

The container 100 may further include the camera 104 and the camera mounting part 27 on which the camera 104 is mounted. In addition, the cover 10 may be formed with a recessed portion S1 that exposes the camera 104 disposed on the camera mounting part 27.

The camera mounting part 27 may be disposed on any one of the cover 10 and the body 20. In FIGS. 9 and 10, it is illustrated that the camera mounting part 27 is disposed on the body 20, but it is merely an example for convenience of description.

The recessed portion S1 formed in the cover 10 may expose the camera 104 to the outside. In addition, the recessed portion S1 may expose a portion or all of the camera mounting part 27 to the outside. Therefore, the camera 104 may operate regardless of the open/closed state of the cover 10.

That is, since the camera 104 may function through the recessed portion S1 both when the cover 10 is in the closed state or the open state, there is an advantage that there is no need to separately provide a camera that functions when the cover 10 is in the closed state and a camera that functions when the cover 10 is in the open state. That is, there is an advantage that manufacturing costs of the container 100 may be reduced by reducing the number of cameras 104.

When the camera mounting part 27 is disposed on the body 20, an accommodation groove 28 in which the camera mounting part 27 is disposed may be formed in the case 21. The camera mounting part 27 may be rotatable in a state in which the camera mounting part 27 is disposed in the accommodation groove 28. That is, the camera mounting part 27 may be rotatably supported on the body 20.

A rotation shaft supporter (not shown) for supporting a rotation shaft (not shown) of the camera mounting part 27 may be formed in the case 21.

When the camera mounting part 27 is rotatably disposed, there is an advantage that the user may easily adjust a capturing angle of the camera 104 by rotating the camera mounting part 27.

A shape of the camera mounting part 27 may be a cylindrical shape that is easy to rotate.

In addition, at least one protrusion 27a that assists the rotation of the camera mounting portion 27 may be further formed in the camera mounting part 27.

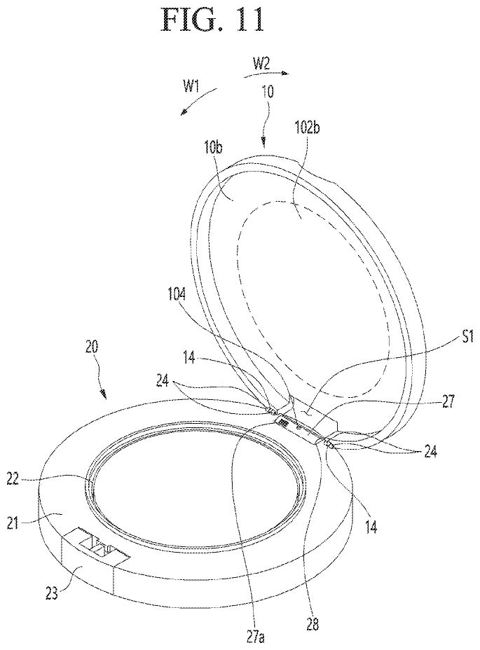

FIG. 11 is a view showing a structure in which a protrusion is formed in the camera mounting part shown in FIG. 10.

When a plurality of protrusions 27a are formed in the camera mounting part 27, the plurality of protrusions 27a may be formed in a rotation direction of the camera mounting part 27.

When there is no protrusion 27a on a surface of the camera mounting part 27, when the user tries to rotate the camera mounting part 27, the surface may be slippery and the camera mounting part 27 may not be easily rotated. However, as shown in FIG. 11, when at least one protrusion 27a is formed on the surface of the camera mounting part 27, the protrusion 27a may minimize a case in which the user's hand slips to easily rotate the camera mounting part 27.

Meanwhile, the display 102 may be disposed on at least one of the outer surface 10a and the inner surface 10b of the cover 10 in which the recessed portion S1 is formed.

When the display 102 is respectively disposed on the outer surface 10a and the inner surface 10b of the cover 10, any one of the display 102a disposed on the outer surface 10ₐ and the display 102b disposed on the inner surface 10b may be turned off according to whether the article accommodation portion 22 is open or closed.

The cover 10 may be inclined in a direction W1 of covering the article accommodation portion 22 or in a direction W2 of opening the article accommodation portion 22.

The cover 10 may be inclined at a first angle that is a maximum angle in a direction W1 of covering the article accommodation portion 22, a second angle that is a maximum angle in a direction of opening the article accommodation portion 22, or a third angle that is an angle between the first angle and the second angle.

The control unit 110 may obtain an angle at which the cover 10 is inclined through the angle sensing module (not shown) connected to the hinge shaft connected between the cover 10 and the body 20.

When the cover 10 is inclined at the first angle, the display 102b disposed on the inner surface 10b may be turned off, and when the cover 10 is inclined at the second angle, the display 102a disposed on the outer surface 10a may be turned off.

When the cover 10 is inclined at the first angle, the display 102a disposed on the outer surface 10a may be turned on and then turned off when a set time elapses, and when the cover 10 is inclined at the second angle, the display 102b disposed on the inner surface 10b may be turned on.

The display 102 may display an image captured by the camera 104 mounted on the camera mounting part 27.

Alternatively, the display 102 may display various information related to the container 100. For example, the information related to the container 100 may include information on the cosmetic material accommodated in the article accommodation portion 22, information on applying a sunscreen detected through the camera 104 and the filter switching device 30, and the like.

The sunscreen application information may include a region where the sunscreen exists, a region where the sunscreen does not exist, a sunscreen application amount, and the like.

The control unit 110 may control the filter switching device 30 in order to obtain the sunscreen application information.

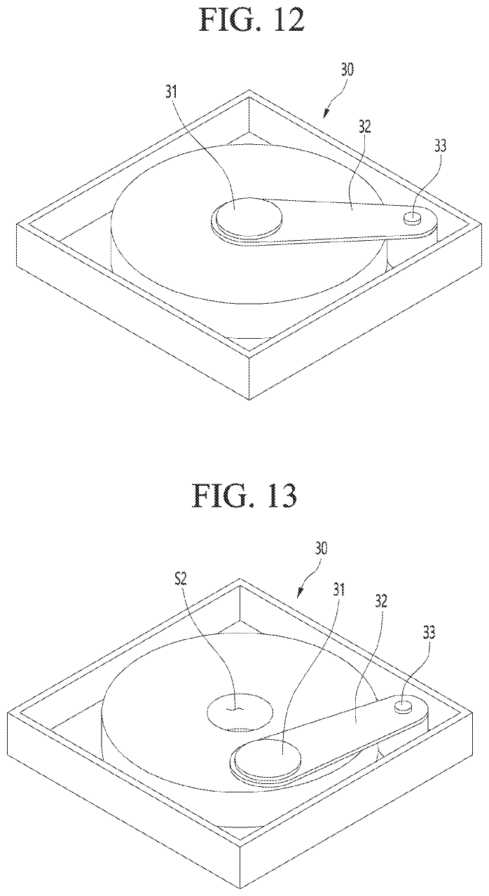

FIGS. 12 to 13 are views showing an example of a structure of a filter switching device according to an embodiment of the present invention.

The filter switching device 30 may transmit only a specific wavelength region and block other wavelengths. For example, the filter switching device 30 may transmit only light corresponding to the ultraviolet wavelength.

The filter switching device 30 may be disposed inside the camera mounting part 27.

The filter switching device 30 may be disposed so that the filter 31 is selectively positioned on an upper portion of the lens of the camera 104.

The filter switching device 30 may include the filter 31, a plate 32 on which the filter 31 is disposed, and a driving unit 33 that rotates the plate 33 at a predetermined angle.

The filter 31 may transmit only an ultraviolet region.

The driving unit 33 may rotate the plate 33 at a predetermined angle. The driving unit 33 may include a motor. The filter 31 may be disposed on the plate 33, and the filter 31 may be positioned parallel with an optical path S2 or spaced apart from an optical path S1 by rotating of the plate 33.

The optical path S2 may be a path through which light collected by the lens of the camera 104 passes. Therefore, when the filter 31 is positioned on the optical path S2 as shown in FIG. 12, the camera 104 may capture an ultraviolet video image, and when the filter 31 is positioned to be spaced apart from the optical path S2 as shown in FIG. 13, the camera 104 may capture a general video image.

When the control unit 110 operates in the sunscreen detection mode, the control unit 110 may control the driving unit 33 so that the plate 33 rotates at an angle that covers the optical path S2. When the control unit 110 does not operate in the sunscreen detection mode, the control unit 110 may control the driving unit 33 so that the plate 33 rotates at an angle that does not cover the optical path S2.

When the plate 33 is rotated at the angle that covers the optical path S2, the control unit 110 may capture the ultraviolet video image through the camera 104.

Hereinafter, the control unit 110 may directly display the ultraviolet video image on the display 102, or may display an image in which the detection region of the sunscreen and the non-detection region of the sunscreen are separated after detecting the region where the sunscreen is applied based on the ultraviolet video image.

That is, the control unit 110 may display the region where the sunscreen is applied and the region where the sunscreen is not applied as image information on the display 102 so that the user may directly confirm the regions.

Therefore, through the image displayed on the display unit 102, the user may directly visually confirm the region where the sunscreen is applied and the region where the sunscreen is not applied.

The control unit 110 may obtain a region of the user's face in which the sunscreen exists and a region of the user's face in which the sunscreen does not exist, based on the ultraviolet ray detection region of the ultraviolet video image. In addition, the control unit 110 may obtain a detection amount of ultraviolet rays from the ultraviolet video image, and thus obtain a sunscreen application amount in the user's face. The control unit 110 may control the display 102 so as to display the sunscreen application amount.

Meanwhile, according to the embodiment, the filter 31 of the filter switching device 30 may transmit only infrared light. The control unit 110 may obtain an infrared video image by positioning the filter 31 that transmits only infrared light on the optical path S2.

The control unit 110 may extract the region where the sunscreen is applied in the user's face through the infrared video image. Specifically, the infrared video image may be represented in different colors according to a temperature distribution. For example, the infrared video image may be represented in a brighter color in a high temperature region and a darker color in a low temperature region.

For example, when ultraviolet rays reach the region where the sunscreen exists in the user's face, the ultraviolet rays are emitted as heat and light and have a high temperature, so that the ultraviolet rays may be represented in white in the infrared video image. On the contrary, the ultraviolet rays may be absorbed by the skin when reaching the region where the sunscreen does not exist the user's face and the temperature does not increase, so that the ultraviolet rays may be represented in black in the infrared video image.

The control unit 110 may obtain the region where the sunscreen exists in the user's face and the region where the sunscreen does not exist in the user's face based on a color distribution of the infrared video image.

Meanwhile, unlike FIGS. 12 to 13, the filter switching device 30 may include a plurality of filters 31.

According to an embodiment, the plate 32 of the filter switching device 30 may be provided with a first filter for transmitting only ultraviolet rays and a second filter for transmitting only infrared rays. The control unit 110 may control the driving unit 33 so that any one of the first filter and the second filter is disposed on the optical path S2.

When the control unit 110 controls the driving unit 33 so that the first filter is disposed on the optical path S2, the control unit 110 may obtain the sunscreen application information through the Ultraviolet video image. Meanwhile, when the control unit 110 controls the driving unit 33 so that the second filter is disposed on the optical path S2, the control unit 110 may obtain the sunscreen application information through the infrared video image.

As described above, when the filter switching device 30 includes the plurality of filters 30, the sunscreen application information may be detected by obtaining the Ultraviolet video image or the infrared video image in consideration of ingredients of the sunscreen. That is, in this case, there is an advantage that it is possible to detect the sunscreen application information regardless of the ingredients of the sunscreen.

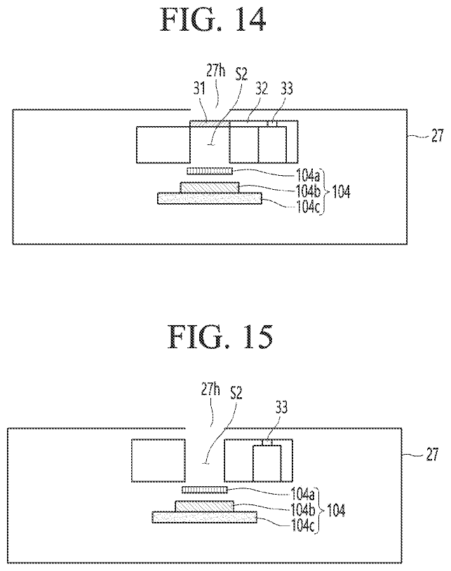

FIGS. 14 to 15 are cross-sectional views showing a filter switching device and a camera according to embodiment of the present invention.

The filter switching device 30 and the camera 104 may be disposed inside the camera mounting part 27.

The camera 104 may include a lens 104a, an image sensor 104b, and a processor 104c.

The lens 104a may be configured to allow a transmittance for light energy in a wavelength range of about 280 to about 400 nm as well as visible rays. UVA corresponds to about 320 to 400 nm, and UVB corresponds to about 280 to 320 nm. Therefore, the lens 104a may be formed of a material that allows transmission of suitable light energy according to UVA or UVB.

According to the embodiment, the lens 104a may be a lens assembly including three lenses. When the lens 104a is a lens assembly including a plurality of lenses, the filter 31 may be disposed between the plurality of lenses.

In the camera 104, the lens 104a may be disposed in parallel with the optical path S2 of the filter switching device 30.

In addition, in the filter switching device 30, the optical path S2 may be disposed in parallel with a camera hole 27h of the camera mounting part 27. That is, the camera hole 27h, the optical path S2, and the lens 104a of the camera mounting part 27 may be disposed side by side in order from an upper side toward a lower side of the camera mounting part 27.

The filter 31 may be selectively disposed between the camera hole 27h and the optical path S2. When displaying a sunscreen detection image, the control unit 170 may control the driving unit 33 so that the filter 31 is positioned between the camera hole 27h and the optical path S2, and when displaying a general image, the control unit 170 may control the driving unit 33 so that the filter 31 is not positioned between the optical path S2 and the camera hole 27h.

The filter 31 may be selected so that the transmittance is maximized in a spectral region where the sunscreen has a maximum absorption in 300 nm to 400 nm and a minimum transmittance outside the region (>400 nm).

The filter 31 may be in optical communication with the lens 104a and an image sensor 104c. The filter 31 may have a high light density of about 390 nm or more and a low light density of about 390 nm or less.

The filter 31 may have a transmittance range corresponding to a wavelength range according to the ingredients of the sunscreen.

For example, when the sunscreen has ingredients that do not absorb light having light energy of 390 nm or more, since a person may not see light of 425 nm or less, the filter 31 may have a transmittance range including 425 nm or less.

The image sensor 104b may be disposed under the lens 104a. The image sensor 104b may be an element that converts light received through the lens 104a into a digital signal.

The control unit 110 may control the driving unit 33 so that the plate 32 rotates, and the filter 31 may be selectively disposed on the optical path S2 by the rotation of the plate 32. The fact that the filter 31 is disposed on the optical path S2, it may refer that the filter 31 exists on a virtual line extending from the optical path S2.

Therefore, as shown in FIG. 15, the image sensor 104b may obtain the general image when the filter 31 does not exist on the virtual line extending from the optical path S2.

As shown in FIG. 14, the image sensor 104b may obtain an image formed of light having a wavelength filtered by the filter 31 when the filter 31 exists on the virtual line extending from the optical path S2. When the filter 31 passes only light of the ultraviolet wavelength, the image sensor 104b may obtain the ultraviolet video image, and when the filter 31 passes only light of the infrared wavelength, the image sensor 104b may obtain the infrared video image.

The processor 104c may transmit an image obtained through the image sensor 104b to the control unit 110. The control unit 110 may obtain the sunscreen application information through the image received from the processor 104c and may control the display 102 so as to display an image showing the sunscreen application information in consideration of the type of sunscreen accommodated in the container or SPF/PA grade information.

Meanwhile, the processor 104c may obtain information such as UW data, an image capture time, a type of sunscreen, an application method, and the like.

The control unit 110 may directly display the ultraviolet video image or the infrared video image on the display 102 or may display an image obtained by analyzing the distribution of the sunscreen based on the ultraviolet video image or the infrared video image on the display 102. Alternatively, the display 102 may display an ultraviolet detection image obtained by passing only ultraviolet light through the filter 31.

That is, the display 102 may display the region where the detected sunscreen exists based on the image captured by the camera 104.

FIGS. 16 to 18 are exemplary views of a method in which a container according to an embodiment of the present invention displays an image showing distribution information of the sunscreen.

The control unit 110 may drive the camera 104 and the filter switching device 30 to capture the users face and obtain the region where the sunscreen exists and the region where the sunscreen does not exist in the user's face.

The region where the sunscreen exists refers to a region where it is estimated that the sunscreen is applied in a certain amount or more.

The region where the sunscreen does not exist refers to a region where it is estimated that the sunscreen is not applied in a certain amount or more. That is, the region where the sunscreen does not exist refers to a region where it is estimated that the sunscreen is applied in an amount less than the certain amount.

The control unit 110 may analyze the ultraviolet video image or the infrared video image to distinguish the region where the sunscreen exists and the region where the sunscreen does not exist in the user's face region.

The control unit 110 may receive a sunscreen display command through an input unit 50.

The input unit 50 may be a physical button provided in the container 100. However, since it is merely an example, the embodiment is not limited thereto.

According to an embodiment, when it is determined that the container 100 is open, the control unit 110 may control the display 102b so as to display the general image captured by the camera 104.

Here, an open state of the container 100 may refer to a state in which the cover 10 is inclined in the direction W2 of opening the article accommodation portion 22.

In addition, the general image may refer to an image obtained by the image sensor 104b in a state in which the filter 31 is not disposed on the optical path S2. The general image is an image as shown in FIG. 16 and may be an image in which only the user's face is shown.

The control unit 110 may sense a pressure applied to a button 50 in a state in which the display 102b is controlled so as to display the general image.

When a pressure higher than a preset reference is applied to the button 50, the control unit 110 may control the display 102b to display the sunscreen detection image instead of the general image. The sunscreen detection image may be an ultraviolet image or an image processed after extracting the region where the sunscreen is applied based on the ultraviolet image.

Meanwhile, when a pressure less than the preset reference is applied to the button 50, the control unit 110 may control the display 102b to display the general image. That is, the image displayed on the display 102b by the button 50 may be switched between the general image and the sunscreen detection image.

The sunscreen detection image may refer to an image obtained by the image sensor 104b in a state in which the filter 31 is disposed on the optical path S2.

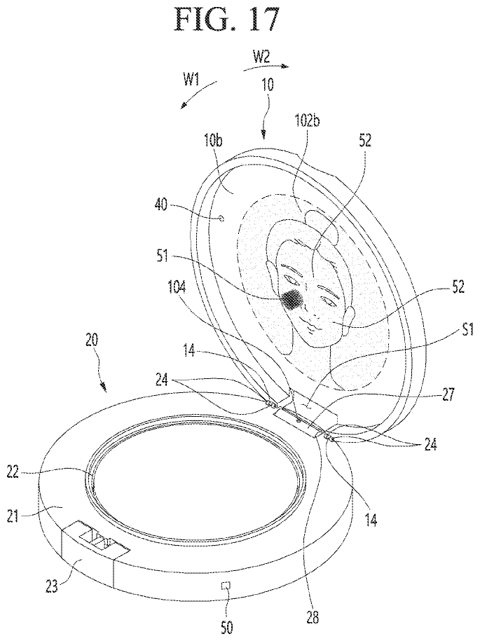

When the control unit 110 displays the sunscreen detection image, as shown in FIG. 17, the user's face is displayed on the display 102b, and a region 52 where the sunscreen is not applied in the user's face may be displayed in black to some extent, and a region 51 where the sunscreen is applied may be displayed in very black. The region 51 where the sunscreen is applied may represent a region where ultraviolet rays are reflected. Alternatively, the region 51 where the sunscreen is applied may represent a high temperature region on the infrared video image.

When the sunscreen detection image is an image processed after analyzing the region where the sunscreen is applied in the ultraviolet video image or the infrared video image, an indicator (not shown) for distinguishing the region where the sunscreen is applied from the region where the sunscreen is not applied may be further included. The indicator (not shown) may be a GUI that overlaps on the general image. In this case, the display 102b may display the sunscreen application information in consideration of the type of sunscreen included in the container or SPF/PA grade information as well as the sunscreen application amount.

When the display 102b displays the sunscreen detection image, the sunscreen non-existing region 52 may be displayed brighter than the sunscreen existing region 51.

There is an advantage that the user may more easily identify a facial region where the sunscreen should be applied by referring to a screen as shown in FIG. 17.

In addition, there is an advantage that the user may easily alternately confirm the general image and the sunscreen detection image through the button 50. The user may confirm an UV-blocking image for a certain period while pressing the button 50 or after touching the button 50 once.

Meanwhile, according to the embodiment, the display 102b may further display the indicator (not shown) indicating the region where the sunscreen does not exist. That is, the display 102b may display a plurality of indicators that respectively indicate the region where the sunscreen exists and the region where the sunscreen does not exist.

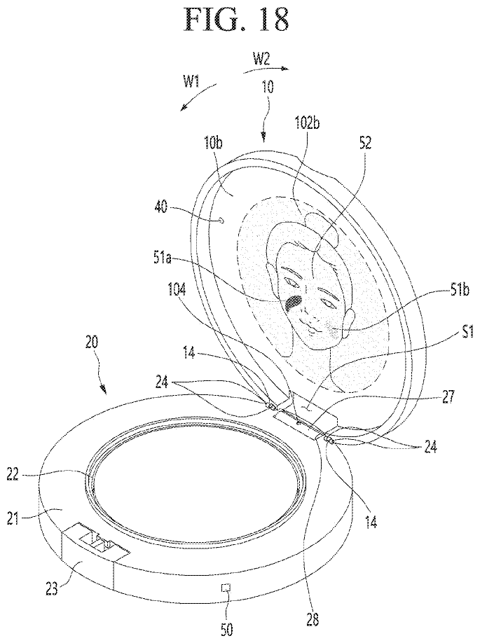

Meanwhile, the display 102 may also display the sunscreen application amount. When the control unit 110 displays the sunscreen detection image, the sunscreen detection image may have different brightness depending on the sunscreen application amount. For example, as shown in FIG. 18, the control unit 110 may display the sunscreen detection image in which a first region 51a having the largest sunscreen application amount is displayed in the darkest color, and a second region 51b having the sunscreen application amount smaller than the first region 51a is displayed in a brighter color than the first region 51a. In this case, a third region 52 where the sunscreen is not applied may be displayed brighter than the first region 51a and the second region 51b. That is, the control unit 110 can control the display 102b so that the region where the sunscreen application amount is larger is displayed darker.

Through this, there is an advantage that the user may easily recognize a region where the sunscreen is insufficient even in the region where the sunscreen is already applied.

Meanwhile, as described above, in order for the control unit 110 to distinguish between the region where the sunscreen exists and the region where the sunscreen does not exist, a certain amount of ultraviolet light emission may be required.

According to an embodiment, as shown in FIGS. 16 to 18, the container 100 may further include a light-emitting unit 40. The light-emitting unit 40 may be a light-emitting diode (LED).

The light-emitting unit 40 may emit a certain amount of ultraviolet rays while operating in the ultraviolet blocking agent detection mode. The light-emitting unit 40 may emit ultraviolet rays in the direction of the user's face.

The light-emitting unit 40 may be disposed on the inner surface 10b of the cover 10. For example, the light-emitting unit 40 may be disposed between an outer circumference of the cover 10 and an outer circumference of the display 102b among the inner surface 10b of the cover 10. However, it is merely an example, and the light-emitting unit 40 may be disposed on the body 20.

In addition, the light-emitting unit 40 may emit infrared rays or the like in addition to ultraviolet rays. For example, the container 100 may operate in a skin care mode, and when the container 100 operates in the skin care mode, the light-emitting unit 40 may emit the infrared rays. When the user is making up using the cosmetic material accommodated in the container 100 or inputs a skin care command, the control unit 110 may control the operation mode of the container 100 as the skin care mode.

When the container 100 does not include the light-emitting unit 40, the sunscreen detection region and the sunscreen non-existing region may be distinguished when the container 100 is positioned outdoors during the daytime.

When the current position detected by the position detection unit (not shown) corresponds to the outdoors, and the current time corresponds to a set time (e.g., 10:00 am to 05:00 pm) at which ultraviolet rays are detected, the container 100 may operate in the sunscreen detection mode that distinguishes between the sunscreen detection region and the sunscreen non-existing region.

In addition, the container 100 may output an alarm for using the sunscreen. Specifically, the control unit 110 may output the alarm for using the sunscreen based on weather information, cosmetic information received in the article accommodation portion 22, and usage information of the cosmetic product accommodated in the article accommodation portion 22.

First, the control unit 110 may obtain weather information such as a current UV index through the communication unit 103 or the ultraviolet sensing unit (not shown). For example, the control unit 110 may control the communication unit 103 so as to receive the current UV index from an external server, or may control the UV sensing unit (not shown) so as to measure the current UV amount. Cosmetic information accommodated in the article accommodation portion 22 may be input through the input unit 105. For example, when the sunscreen is accommodated in the article accommodation portion 22, the control unit 110 may receive UV protection index such as SPF or PA as the cosmetic information through the input unit 105. The input unit 105 may be directly receive the UV protection index from the user through a key button or the like, or may receive the UV protection index through the QR code for the cosmetics accommodated in the article accommodation portion 22.

The control unit 110 may obtain the usage information of the sunscreen through at least one of the position detection unit (not shown), the opening/closing detection unit (not shown), and the remaining amount detection unit (not shown).

The control unit 110 may obtain the current position through the position detection unit (not shown), and through this, it is possible to sense whether the current position of the user is indoors or outdoors. In addition, the control unit 110 may obtain a time when the container 100 is open or closed through the opening/closing detection unit (not shown). The control unit 110 may recognize the time when the container 100 is opened and closed as a usage time of the cosmetics. In addition, the control unit 110 may detect the remaining amount of the cosmetics accommodated in the article accommodation portion 22 when the container 100 is open. The control unit 110 may obtain a usage amount of cosmetics through a change in the remaining amount of the cosmetics detected by the remaining amount detection unit (not shown) when the container 110 is open. In this way, the control unit 110 may obtain the current position, the usage time of cosmetics, and the usage amount of cosmetics through the position detection unit (not shown), the opening/closing detection unit (not shown), and the remaining amount detection unit (not shown).

Through the above-described method, for example, the control unit 110 may obtain information on which the user is active outdoors and uses 2 g of an SPF 35 sunscreen at 8:00 am.

The control unit 110 may output the alarm indicating that the use of the sunscreen is necessary when a reference time (e.g., three hours) has elapsed from the usage time of the cosmetics (e.g., 8:00 am). In this case, the reference time is a time calculated through the current UV index and the usage amount of the sunscreen, and may be a time at which the effect of the sunscreen is predicted to be the reference value or less.

The control unit 110 may transmit an alarm request signal to the mobile terminal 200 so that the mobile terminal 200 connected to the container 100 through the communication unit 103 outputs the alarm for using the sunscreen. The mobile terminal 200 may control the display unit 203 so as to output the alarm for using the sunscreen according to receive the alarm request signal. Of course, the control unit 110 may output the alarm for using the sunscreen on the display 102 of the container 100.

As described above, the control unit 110 may provide information on cosmetics currently required by the user based on the information on the cosmetics accommodated in the container 100 and the usage information on the cosmetics.

Meanwhile, the control unit 110 may measure a skin condition of the user's face based on the image captured by the camera 104 mounted on the camera mounting part 27. The display 102 may display the measured skin condition of the user's face. At this time, the skin condition may be wrinkles, elasticity, aging, and the like, but it is merely an example.

For example, the control unit 110 may measure the skin condition using at least one of the camera 104 and the light-emitting unit 40. Specifically, the control unit 110 may control the light-emitting unit 40 so as to irradiate ultraviolet rays, and in this case, a melanin pigment damaged under the epidermis of the skin may react with the ultraviolet rays. As described above, the control unit 10 may measure the degree of skin aging by measuring autofluorescence emitted as ultraviolet rays react with the melanin pigment and analyzing a fluorescence intensity ratio of specific wavelengths through a fluorescence spectrum.

The above-described descriptions are merely illustrative of the technological spirit of the present invention, and various modifications and variations may be made by those having ordinary skill in the art to which the present invention pertains without departing from the essential characteristics of the present invention.

Therefore, the embodiments disclosed in the present invention are not intended to limit the technological spirit of the present invention, but the embodiments are intended to describe, and the spirit and scope of the present invention is not limited by such embodiments.

The protection scope of the present invention should be construed by the following claims, and all technological spirits within the equivalent scope thereof should be construed as being included in the scope of right of the present invention.

1. A container comprising:
a body having an article accommodation portion formed therein;
a cover for opening and closing the article accommodation portion; and
a camera mounting part disposed on any one of the body and the cover,
wherein a recessed portion for exposing a camera disposed on the camera mounting part is formed on the cover.

2. The container of claim 1, wherein the camera mounting part is disposed on the body.

3. The container of claim 2, wherein the camera mounting part is rotatably supported on the body.

4. The container of claim 3, wherein at least one protrusion is formed in the camera mounting part.

5. The container of claim 1, further comprising a display disposed on at least one of an inner surface and an outer surface of the cover.

6. The container of claim 5, wherein the display displays an image captured by the camera mounted on the camera mounting part.

7. The container of claim 6, wherein the display displays a region where a sunscreen is detected based on the image captured by the camera.

8. The container of claim 5, wherein when the display is disposed on each of the inner and outer surfaces of the cover, one of the display disposed on the inner surface and the display disposed on the outer surface is turned off depending on whether the article accommodation portion is open or closed.

9. The container of claim 8, wherein the cover is inclined at a first angle that is a maximum angle in a direction of covering the article accommodation portion, a second angle that is a maximum angle in a direction of opening the article accommodation portion, or a third angle that is an angle between the first angle and the second angle.

10. The container of claim 9, wherein when the cover is inclined at the first angle, the display disposed on the inner surface is turned off, and
when the cover is inclined at the second angle, the display disposed on the outer surface is turned off.

11. The container of claim 9, wherein when the cover is inclined at the first angle, the display disposed on the outer surface is turned on and then turned off when a set time elapses, and
when the cover is inclined at the second angle, the display disposed on the inner surface is turned on.

12. The container of claim 8, further comprising a sensing unit for determining whether the article accommodation portion is open or closed.

13. The container of claim 1, wherein at least one of a cosmetic material and a puff is accommodated in the article accommodation portion.

14. The container of claim 1, wherein at least one light-emitting unit is disposed on the cover.

15. The container of claim 1, further comprising a control unit that measures a skin condition of a user's face based on an image captured by the camera mounted on the camera mounting part.
